(19) United States
(12) Patent Application Publication
(10) Pub. No.: US 2009/0055260 A1
(43) Pub. Date: Feb. 26, 2009

(54) Online system for renting application software

(76) Inventor: William Henry Ensign, Stamford, CT (US)

Correspondence Address: AMSTER, ROTHSTEIN & EBENSTEIN LLP, 90 PARK AVENUE, NEW YORK, NY, 10016, US

(21) Appl. No.: 11/894,963

(22) Filed: Aug. 22, 2007

(51) Int. Cl. G06Q 30/00

(52) U.S. Cl. 705/14; 705/26

(57) ABSTRACT

A method for renting application software to a customer including the steps of: offering to the customer access to one or more application software products; receiving a signal indicating the customer's selection of a software product from the one or more software products; providing the customer with access to the selected software product for a period of time; and receiving payment from the customer in return for providing the customer with access to the selected software product, wherein the step of offering one or more application software products comprises selecting appropriate software products to offer based on the customer's requirements.

### FIELD OF THE INVENTION

The present application is related to systems and methods for providing services on the Internet, and in particular to systems and methods for providing online access to a variety of application software products over the Internet.

### BACKGROUND OF THE INVENTION

The current landscape of the software marketplace makes it very difficult for all but just a few software companies to sell their products. The key software vendors, through a long history of advertising and brand development, have generated a market where the typical buyer is convinced that the risk of buying from non-key vendors is not worth the potential rewards of buying from relatively unknown vendors. Most customers are simply not aware that other options exist besides purchasing software products from the well-known software vendor companies.

Some effort has been made to address the above-discussed problem, such as legislation which has resulted in monopoly charges against key software companies, the development of shareware which provides customers access to trial software prior to purchase, and freeware which provides software for free with open architecture. However, each of these efforts have failed to positively effect the software market. In the case of legislation, monopoly charges have not changed the software industry, in that only a few software companies are leading the way. In the case of shareware, the software vendor typically does not generate enough money to develop and support the offered software, and there is typically relatively low exposure to such shareware. In regards to freeware, as with shareware, the vendor typically does not generate enough money and there is little exposure, and in addition, the responsibility for correction of the software is left undefined.

Thus, there is a need for a software vending environment in which the software vendor benefits from relatively effective exposure of the software product and by profit resulting from such exposure, while also providing the consumer with confidence in the software product.

### SUMMARY OF THE INVENTION

A method for renting application software to a customer according to an exemplary embodiment of the present invention comprises the steps of: offering to the customer access to one or more application software products; receiving a signal indicating the customer's selection of a software product from the one or more software products; providing the customer with access to the selected software product for a period of time; and receiving payment from the customer in return for providing the customer with access to the selected software product, wherein the step of offering one or more application software products comprises selecting appropriate software products to offer based on the customer's requirements.

In at least one embodiment, the method further comprises providing assistance to the customer in using the selected software product.

In at least one embodiment, the step of providing assistance comprises providing the customer with access to one or more online help resources.

In at least one embodiment, the step of receiving payment comprises routing at least a portion of the payment to the one or more online help resources.

In at least one embodiment, the step of offering one or more application software products comprises displaying advertisements for the one or more application software products.

In at least one embodiment, the step of receiving payment comprises receiving payment on a time basis.

In at least one embodiment, at least a portion of the payment is routed to a vendor of the selected software product.

In at least one embodiment, the method further comprises providing a rating for each of the one or more software products.

A system for renting application software to a customer according to an exemplary embodiment of the present invention comprises: an offer manager that offers to the customer at an Internet website access to one or more application software products, while providing assistance in selecting the software product; a signal manager that receives signals indicating the customer's selection of a software product from the one or more software products; a portal that provides the customer with access to the selected software product for a period of time; and a payment manager that receives payment from the customer in return for providing the customer with access to the selected software product.

A portal for renting application software to a customer according to an exemplary embodiment of the present invention comprises: an offer manager that offers to the customer at an Internet website access to one or more application software products, while providing assistance in selecting the software product; a vendor manager that coordinates contacts between vendors and customers; a signal manager that receives signals indicating the customer's selection of a software product from the one or more software products; and a payment manager that receives payment from the customer in return for providing the customer with access to the selected software product, wherein the portal provides the customer with access to a selected software product for a period of time.

In at least one embodiment, the vendors includes at least a software vendor and a help vendor.

In at least one embodiment, portal further comprises an advertising manager that provides advertising to the customer.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a diagram of a system for renting application software according to an exemplary embodiment of the present invention; and

FIG. 2 is a flowchart showing a method of renting application software according to an exemplary embodiment of the present invention.

### DETAILED DESCRIPTION OF PREFERRED EMBODIMENTS

The present invention is directed to a system and method for providing online customers with access to a variety of software products and software assistance services to aid the customer in performing and completing a particular project. The system may be operated by an online portal provider that is in agreement with a variety of software vendors to provide software services and products. In at least one exemplary embodiment, the customer may access a help center where the customer can obtain advice on preferred software categories and products which would be most useful to the customer in completing the project. Alternatively, or in addition, the customer may browse through a variety of software categories and products, and have the option to select one or more software products for use. While using the software, the customer may also access software assistance providers, which may be independent of or affiliated with the software vendor. Preferably, the customer pays for access to the selected software and software assistance providers on a time basis. Payment may be made to the portal provider, which in turn sends a portion of the payment to the software vendor to compensate the vendor for allowing access to the software and/or software services.

The present invention is preferably operated over the Internet, to allow the general public, including companies and individuals, to access the software portal, preferably through a secure connection. However, it should be appreciated that the present invention may be operated over any type of network, such as, for example, an intranet, a local area network (LAN) or a wide area network (WAN).

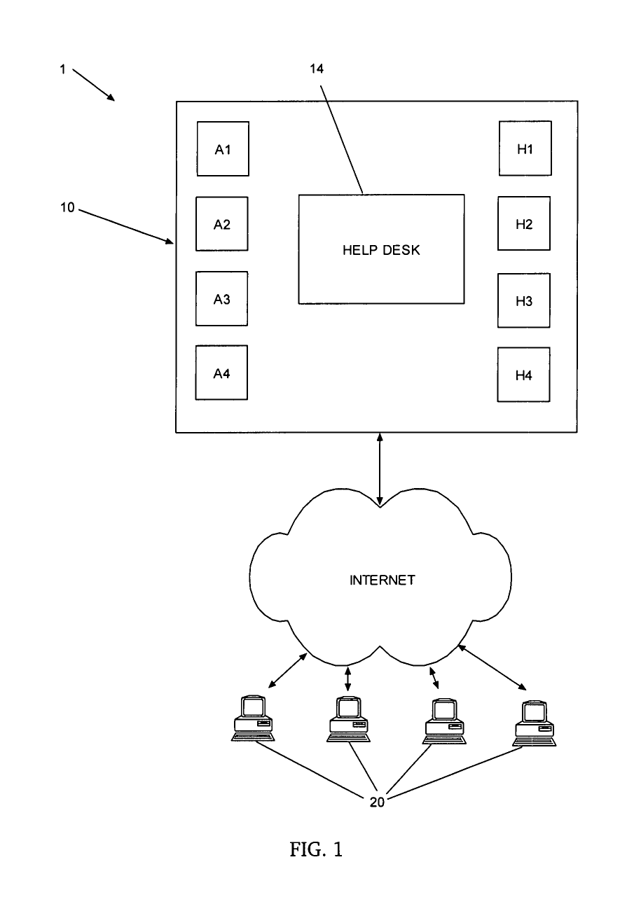

FIG. 1 is a diagram of a system, generally designated by reference number 1, for renting application software according to an exemplary embodiment of the present invention. The system 1 includes a portal provider 10 and customers 20, communicating with one another over the Internet, or alternatively over some other type of network. Although FIG. 1 represents the customers 20 as computer workstations, it should be appreciated that the customers 30 may communicate with the portal provider 10 by other means besides a computer, such as, for example, any text messaging-enabled device, such as a cell phone.

The portal provider 10 preferably maintains a web site at a location defined by a uniform resource locator (URL) on the Internet. The web site may be a secure site that allows access to its one or more pages only after a visitor inputs a logon ID and password. The web site may provide one or more graphical user interface (GUI) pages for use by the customers 20 to input project requirements and other information that can be used by the portal provider 10 in guiding the customers 20 to appropriate software. The web site also may provide the customers 20 with the ability to search for and browse through a list of available software so that the customers 20 can choose software as an alternative or in addition to the software recommended by the portal provider 10.

In a preferred embodiment, the portal provider 10 includes a help desk 14 that may present a list of recommended software vendors A1-A4 and software-related service providers H1-H4 that would be the most effective for the customer's project. In this regard, the help desk 14 may include a messaging feature that allows a customer 20 to communicate with a help desk professional, such as, for example, an instant messaging feature that allows for live interaction. In other embodiments, the help desk 14 may be fully automated. For example, selection of appropriate software vendors and software-related service providers may be performed using a keyword search performed by a search engine.

Each vendor A1-A4 and software-related service provider H1-H4 in the list presented to the customer 20 may be provided with a rating, which may be based on user feedback or on some other criteria. Also, if a particular software sector is limited in available vendor options, the portal provider 10 may make available ‘house’ software. Once the software sector is populate with enough vendors, the house software may be sold or removed from the web site 12.

The portal provider 10 preferably contracts with the vendors A1-A4 and software-related service providers H1-H4 to provide software products and software assistance to the customers 20. In this regard, the system 1 may be viewed as a “community”, in which the portal provider 10 may set up by-laws that allow vendor voting rights, including the right to change the by-laws. For example, it may be a requirement that, in order for a vendor to qualify as a member of the software portal system 1, assistance for the software offered by the vendor must be made available to the customers 20, either directly through the vendor offering the software or through other software-related service providers. Thus, the vendors may vote other vendors out of the system 1 if it is deemed that a vendor is bad for the community, for example, if a vendor offers access to its software at too low a cost, offers low-quality software or is using the community merely as an advertising tool to attract customers away from the community.

Upon selection of a software product provided by one of the vendors, a customer 20 contracts with the portal provider to pay for metered time access to the software product. Preferably, no contracts exist between the customers 20 and the vendors, so that the only communication between the customers 20 and the vendors relates to the actual use of software services provided by the vendors. After the customer 20 is done using the selected software product, the customer 20 pays the portal provider 10 based on the period of time in which the customer 20 accessed the software product. For example, the portal provider 10 may charge a specific dollar amount per minute, hour, day or some other time period for access to the software product. The portal provider 10 then pays a portion of the fees collected by the customer 20 to the vendor as compensation for allowing the customer 20 to access the software product. In this way, since the vendor is assured of payment based on a fixed rate regardless of the customer 20, the vendor is motivated to provide un-biased services and to function as a productive member of the community provided by the system 1. At the same time, it is to the portal provider's 10 best interest to attract a large number and wide variety of vendors to maximize overall profit.

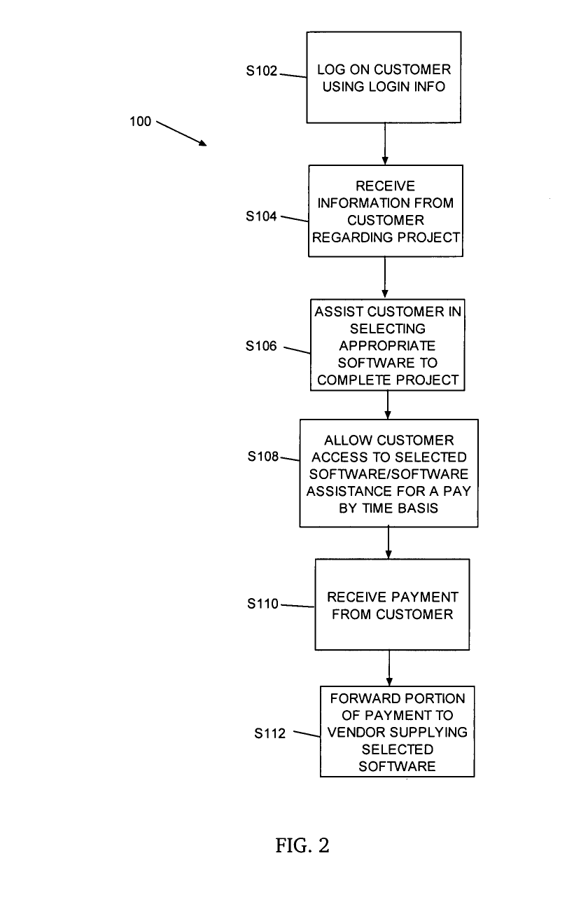

FIG. 2 is a flowchart showing a method, generally designated by reference number 100, of renting application software according to an exemplary embodiment of the present invention. In step S102 of the method 100, a portal provider logs a customer into the software portal after the customer enters, for example, a correct login ID and password combination. In the step S104, the portal provider receives information from the customer regarding the customer's project, including information such as, for example, specific tasks to be performed and the desired format of the project output. The portal provider may receive such information in the form of populated GUI pages, which may include pull down menus and other data input mechanisms that allow the customer to provide project details.

In step S106, the portal provider assists the customer in selecting appropriate software products and services that would aid the customer in completing the project. In the regard, the portal provider may provide a list of vendors offering a particular type of software product/service, along with information regarding the vendors, such as, for example, vendor ratings, pricing, and a description of the capabilities of the software product/service. Alternatively, or in addition, the portal provider may present a general list of available vendors, in which the customer may browse to select an appropriate vendor without the aid of the portal provider.

In step S108, the portal provider allows the customer access to the selected software product along with assistance with the software product, which may be provided by the same vendor or another vendor. Customer access is preferably provided and billed on a time basis, such as, for example, a particular dollar amount per minute. Upon completion of the project, the customer may log off the system, at which point a bill may be automatically generated based on the amount of time the customer spent using the selected software product. The bill may be provided to the customer by any suitable means, such as, for example, via e-mail or regular mail.

In step S110, the portal provider receives payment from the customer based on the amount billed. Payment may be received by any suitable means, such as, for example, deducting the billed amount from a portal account previously funded by the customer.

In step S112, the portal provider forwards a portion of the payment to the vendor or vendors that supplied the selected software product to the customer. The size of the portion is preferably determined based on a prior agreement between the portal provider and the vendors.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for renting application software to a customer, comprising:
offering to the customer access to one or more application software products;
receiving a signal indicating the customer's selection of a software product from the one or more software products;
providing the customer with access to the selected software product for a period of time; and
receiving payment from the customer in return for providing the customer with access to the selected software product,
wherein the step of offering one or more application software products comprises selecting appropriate software products to offer based on the customer's requirements.

2. The method of claim 1, further comprising providing assistance to the customer in using the selected software product.

3. The method of claim 2, wherein the step of providing assistance comprises providing the customer with access to one or more online help resources.

4. The method of claim 3, wherein the step of receiving payment comprises routing at least a portion of the payment to the one or more online help resources.

5. The method of claim 1, wherein the step of offering one or more application software products comprises displaying advertisements for the one or more application software products.

6. The method of claim 1, wherein the step of receiving payment comprises receiving payment on a time basis.

7. The method of claim 1, wherein at least a portion of the payment is routed to a vendor of the selected software product.

8. The method of claim 1, further comprising providing a rating for each of the one or more software products.

9. A system for renting application software to a customer, comprising:
an offer manager that offers to the customer at an Internet website access to one or more application software products, while providing assistance in selecting the software product;
a signal manager that receives signals indicating the customer's selection of a software product from the one or more software products;
a portal that provides the customer with access to the selected software product for a period of time; and
a payment manager that receives payment from the customer in return for providing the customer with access to the selected software product.

10. A portal for renting application software to a customer, comprising
an offer manager that offers to the customer at an Internet website access to one or more application software products, while providing assistance in selecting the software product;
a vendor manager that coordinates contacts between vendors and customers;
a signal manager that receives signals indicating the customer's selection of a software product from the one or more software products; and
a payment manager that receives payment from the customer in return for providing the customer with access to the selected software product,
wherein the portal provides the customer with access to a selected software product for a period of time.

11. The portal of claim 10, wherein the vendors includes at least a software vendor and a help vendor.

12. The portal of claim 10, further comprising an advertising manager that provides advertising to the customer.
